(19) United States
(12) Patent Application Publication
(10) Pub. No.: US 2006/0198429 A1
(43) Pub. Date: Sep. 7, 2006

(54) Isolating circuit of transmitting and receiving paths in same frequency carrier

(75) Inventors: Hwai-Shen Huang, Hsinchu (TW); Yao-Nan Huang, Hsinchu (TW); Yu-Cheng Weng, Hsinchu (TW); Yao-Cheng Yeh, Hsinchu (TW)

Correspondence Address: OLIFF & BERRIDGE, PLC, P.O. BOX 19928, ALEXANDRIA, VA, 22320, US

(73) Assignee: MICROELECTRONICS TECHNOLOGY INC., HSINCHU (TW)

(21) Appl. No.: 11/243,984

(22) Filed: Oct. 6, 2005

(30) Foreign Application Priority Data
Mar. 2, 2005 (CN) 094203185

(51) Int. Cl. H04L 5/16; H04B 15/00

(52) U.S. Cl. 375/219; 375/285

(57) ABSTRACT

An isolating circuit of transmitting and receiving paths in the same frequency carrier comprises a directional coupler, a phase adjuster, and a mixer. The directional coupler couples a transmitting signal on the transmitting path to the phase adjuster. There is a 90-degree phase difference between an output signal of the phase adjuster and the transmitting signal. The mixer shifts the output signal of the phase adjuster by a 90-degrees phase. Due to poor isolation, a leakage signal is leaked from a transmitting path to a receiving path. The leakage signal is mixed with an output signal of the mixer on the receiving path, and the two signals cancel each other.

### BACKGROUND OF THE INVENTION

(A) Field of the Invention

The present invention is related to an isolating circuit, and more specifically to an isolating circuit of transmitting and receiving paths in the same frequency carrier.

(B) Description of the Related Art

As wireless LAN becomes more and more popular, demand for wireless transmission increases as well.

In general, wireless transmission adopts the method of time division duplexing (TDD), which transmits and receives signals respectively in burst mode. FIG. 1 shows a schematic drawing of a wireless transmitting and receiving apparatus of prior art. A first switch 11 is placed between the antenna 17 and one end of the transmitting and receiving apparatus 10. A second switch 14 is placed between the other end of the transmitting and receiving apparatus 10 and the wireless transmission facilities or access point systems (not shown in FIG. 1). The transmission path of the transmitting and receiving apparatus 10 depends on the first switch 11 and the second switch 14. Either the transmitting signal circuit 13 on the transmitting path 16 or the receiving signal circuit 12 on the receiving path 15 is selected for transmitting or receiving. But each time only one path is enabled. While the transmitting and receiving apparatus 10 is in transmitting mode, some leakage signals are leaked to the receiving path 15 because of poor isolation of the switch 11. This will influence the quality of a receiving signal.

As mentioned above, an isolating circuit eliminating leakage signals is needed to produce a better quality of transmitting and receiving signals.

### SUMMARY OF THE INVENTION

The objective of the present invention is to provide an isolating circuit of transmitting and receiving paths in the same frequency carrier. The circuit can couple and shift a transmitting signal on a transmitting path to a receiving path. The present invention can eliminate a leakage signal on the receiving path, so it can improve sensitivity of the receiving circuit.

To achieve the above objective, the present invention discloses an isolating circuit of transmitting and receiving paths in the same frequency. The isolating circuit comprises a directional coupler, a phase adjuster, and a mixer. The directional coupler couples a transmitting signal on the transmitting path to the phase adjuster. There is a first phase difference between an output signal of the phase adjuster and the transmitting signal. The mixer shifts a second phase of the output signal of the phase adjuster. Due to poor isolation, the leakage signal is leaked from the transmitting path to the receiving path. The leakage signal is mixed with the output signal of the mixer on the receiving path and these two signals cancel each other.

### BRIEF DESCRIPTION OF THE DRAWINGS

FIG. 1 shows a schematic drawing of a wireless transmitting and receiving apparatus of prior art;

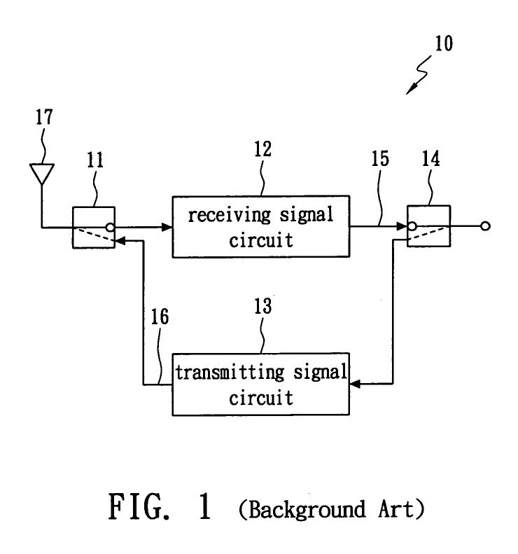

FIG. 2 shows a schematic drawing of an isolating circuit of transmitting and receiving paths in the same frequency carrier in accordance with the present invention; and

FIG. 3 shows a waveform drawing of various signals of the present invention.

### DETAILED DESCRIPTION OF THE INVENTION

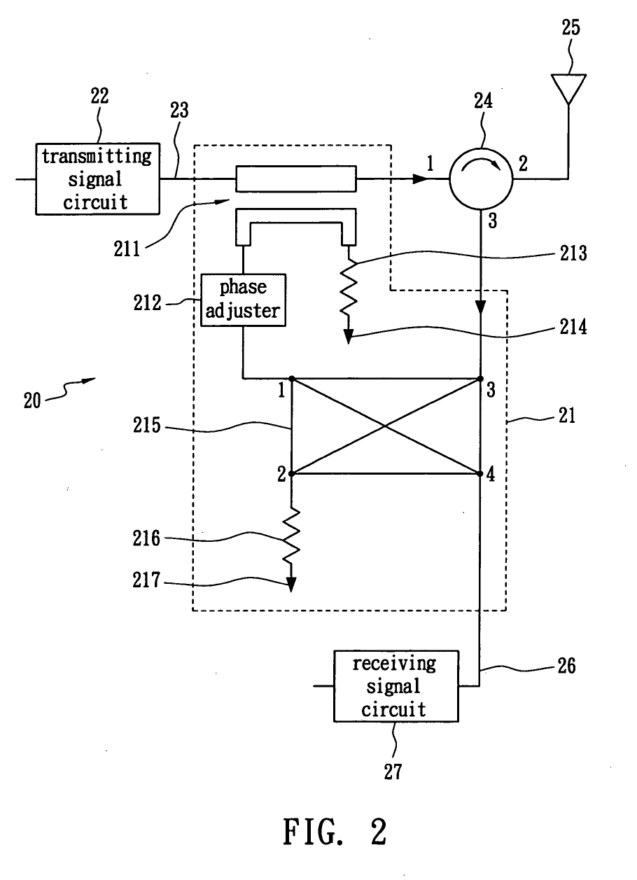

FIG. 2 shows a schematic drawing of an isolating circuit 21 of transmitting and receiving paths in the same frequency carrier in accordance with the present invention. While port 1 and port 2 of a circulatory machine are enabled, a transmitting and receiving circuit 20 is set to transmitting mode. Consequently, a transmitting signal circuit 22 can transmit a signal to an antenna 25 by way of a transmitting path 23 and a circulatory machine 24. In general, isolation of the circulatory machine 24 is so poor (approximately 20˜25 dB) that the isolation between port 1 and port 3 of the circulatory machine 24 is not 100 percent. Consequently, a part of the transmitting signal is leaked to a receiving path 26 and is regarded as a receiving signal by a receiving signal circuit 27. This will result in poor sensitivity in the receiver.

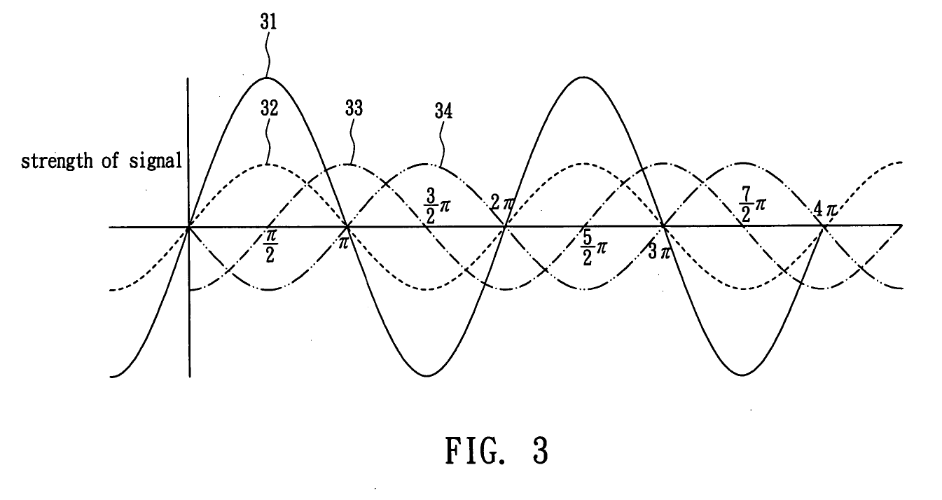

The isolating circuit 21 of the present invention is placed between the transmitting path 23 and the receiving path 26. It can eliminate the leakage signal resulting from poor isolation of the receiving path 26. So, the present invention can be applied to a RFID reader or a wireless communication system, more specifically to a circuit system in which transmitting and receiving paths are in the same frequency. The isolating circuit 21 comprises a directional coupler 211, a phase adjuster 212, and a mixer 215. The directional coupler 211 couples a transmitting signal 31 (referring to FIG. 3) on the transmitting path 23 to the phase adjuster 212. The phase adjuster 212 shifts a 90-degree phase of the coupling signal to produce a signal 33. The signal 33 will be inputted to port 1 of the mixer 215. Then the mixer 215 shifts a 90-degree phase of the signal 33 to produce a signal 34 on port 4. The signal 34 is inputted to the receiving path 26. The leakage signal 32 will be inputted to the port 3 of the mixer 215 simultaneously and then be outputted from port 4. The leakage signal 32 outputted from port 4 is mixed with the shifted 180-degree phase of the coupling signal. Moreover, a 50-ohm resistor 213 is placed between the other end of the directional coupler 211 and the ground 214. The resistor 213 and ground 214 are regarded as a set of dummy load. Similarly, a 50-ohm resistor 216 is placed between port 2 of the mixer 215 and the ground 217, so as to keep a signal of port 2 from reflecting to the other ports.

As shown in FIG. 3, by tuning the coupling factor of the directional coupler 211, the leakage signal 32 and the coupling signal 34 become equally strong; thus the leakage signal 32 and the coupling signal 34 can cancel each other. In practice, it can eliminate the leakage signal 32 on the receiving path 26 by making the leakage signal 32 and the coupling signal 34 equal, and tuning the phase difference of these two signals to odd multiples of 180 degrees.

The above-described embodiments of the present invention are intended to be illustrative only. Numerous alternative embodiments may be devised by those skilled in the art without departing from the scope of the following claims.

What is claimed is:

1. An isolating circuit of transmitting and receiving paths in the same frequency carrier, the isolating circuit being placed between a transmitting path and a receiving path, comprising:
a directional coupler on the transmitting path for transforming a transmitting signal into a coupling signal;
a phase adjuster for adjusting a phase of the coupling signal; and
a mixer for mixing an output signal of the phase adjuster with a leakage signal on the receiving path so that these two signals cancel each other, wherein the leakage signal results from a part of the transmitting signal being leaked to the receiving path.

2. The isolating circuit of transmitting and receiving paths in the same frequency carrier of claim 1, wherein the phase adjuster makes the coupling signal have a first phase shift.

3. The isolating circuit of transmitting and receiving paths in the same frequency carrier of claim 2, wherein the mixer makes the output signal of the phase adjuster have a second phase shift, the sum of the first shift and the second shift being odd multiples of 180 degrees.

4. The isolating circuit of transmitting and receiving paths in the same frequency carrier of claim 1, wherein the directional coupler has an adjustable coupling factor, and the leakage signal and the coupling signal can have equal strength by tuning the coupling factor.

5. The isolating circuit of transmitting and receiving paths in the same frequency carrier of claim 1, wherein the mixer comprises a first port, a second port, a third port and a fourth port; the output signal of the phase adjuster is inputted to the first port and is shifted by a 90-degree phase and then is outputted from the fourth port; the leakage signal is inputted to the third port and is outputted from the fourth port.

6. The isolating circuit of transmitting and receiving paths in the same frequency carrier of claim 5, wherein a 50-ohm resistor is connected in series between the second port of the mixer and the ground.

7. The isolating circuit of transmitting and receiving paths in the same frequency carrier of claim 1, wherein the directional coupler has an end coupled to ground through a 50-ohm resistor, and the end is different from the output end of the coupling signal.
